(19) United States
(12) Patent Application Publication
(10) Pub. No.: US 2004/0142010 A1
(43) Pub. Date: Jul. 22, 2004

(54) Insect repellent candle form

(76) Inventor: Constantinos Maravelis, Kanata (CA)

Correspondence Address: Constantinos Maravelis, 99 Connelly Place, Kanata, ON, K2L 4C1, CA

(21) Appl. No.: 10/613,024

(22) Filed: Jul. 7, 2003

Related U.S. Application Data
(60) Provisional application No. 60/393,557, filed on Jul. 5, 2002.

(30) Foreign Application Priority Data
Jul. 5, 2001 (CA) 2,352,448

(51) Int. Cl. A01N 25/00

(52) U.S. Cl. 424/405

(57) ABSTRACT

An insect repellent in candle form consists essentially of, by weight:

79.80 to 99.60% wax/waxy products,

0.1 to 10% D-allethrin,

0.1 to 10% piperonyl butoxide,

At least 0.1 butyloted hydroxytoluene (BHT), and minor amounts of colouring and perfume.

This invention relates to an insect repellent in candle form. Insect repellents of the type described herein are already available in the marketplace, for example so-called citronella candles which come in small buckets or glass containers. The candles include a wax substrate or base containing a wick and an active ingredient named citronella.

While the composition displays a certain level of insect repellency at close range, there still exists a need for a insect repellent composition, which when used in the same environment as the citronella candles, effectively repels and/or disables mosquitoes, black flies and other insects.

The object to the present invention is to meet the above-defined need by providing a relatively affective insect repellent composition, which is in the form of a candle for use in the outdoors.

Accordingly, the invention relates to an repellent consisting essentially of, by weight, 79.80 to 99.60% wax, 0.1 to 10% d-allethrin, and 0.1 to 10% piperonyl butoxide.

As mentioned above, the composition of the present invention is intended as a substitute for the existing wax-based composition. The main ingredient of the composition is wax, preferably paraffin, which makes up 79.80 to 99.60 by weight of the composition. The wax is melted, the active ingredient of the composition are mixed into the liquid wax to make a homogeneous mixture. The resulting composition is poured into a container, e.g. a small bucket, and a wick is suspended in the centre of the wax until the latter hardens.

The acting ingredients include allethrins, preferably d-allethrin, and piperonyl butoxide. As described, for example in various editions of in The Merck index, allethrins are known, effective insecticides.

Piperonyl butoxide, which is also listed in various editions of the Merck index, is an insecticide synergist, especially for pyrethroids such as the allethrins and rotenone. Butylated hydroxytoluene (BHT) is an antioxidant used in the food and other industries. BHT is used in the composition as a preservative. Conventional colouring compounds and perfume are also added to the composition. The composition contains by weight: 79.80 to 99.60% wax, and at least 0.1 to 5% d-allethrin, 0.1 to 10% piperolyn butoxide, at least 0.1% BHT, and 0.1% colouring and perfume.

The preferred composition consists essentially of 99.60% was, at least 0.1% d-allethrin, at least 0.1% piperonyl butoxide, at least 0.1% BHT and 0.1% colouring and perfume to a total of 100%.

As mentioned above, the ingredients are mixed to form a homogenous mixture which is poured into containers such as glass-shapes candles holders or small buckets. When used outdoors is a more effective insect repellent than existing products of the same general type.

The Embodiments of the Invention in which an Exclusive Property or Privilege is claimed are Defined as Follows:

1. An insect repellent consisting essentially of, by weight, 79.80 to 99.60% wax, 0.1 ti 10% d-allethrin, and 0.1 to 10% piperonyl butoxide.

2. The insect repellent of claim 1, including at least 0.1% by weight butylated hydroxytoluene.

3. The insect repellent of claim 2, including at least 0.1% by weight, colouring and perfume.

4. An insect repellent consisting essentially of, by weight, 79.80 to 99.60 wax, 0.1 to 5% d-allethrin, 0.1 to 5% piperonyl butoxide, at least 0.1 butylated hydroxytoluene and at least 0.1% colouring and perfume.

5. The insect repellent of claim 4, consisting essentially, by weight, of 99.60% wax, at least 0.1% d-allethrin, at least 0.1% piperonyl butoxide, at least 0.3% butylated hydroxytoluene, and at least 0.1% colouring and perfume to a total of 100%.
